(19) United States
(12) Patent Application Publication
(10) Pub. No.: US 2007/0011444 A1
(43) Pub. Date: Jan. 11, 2007

(54) Method, apparatus and system for bundling virtualized and non-virtualized components in a single binary

(76) Inventors: Steven L. Grobman, El Dorado Hills, CA (US); Michael D. Kinney, Olympia, WA (US); Jeffrey R. Jackson, Newberg, OR (US)

Correspondence Address: INTEL CORPORATION;C/O INTELLEVATE, LLC, P.O. BOX 52050, MINNEAPOLIS, MN, 55402, US

(21) Appl. No.: 11/150,780

(22) Filed: Jun. 9, 2005

(51) Int. Cl. G06F 9/00

(52) U.S. Cl. 713/2

(57) ABSTRACT

A method, apparatus and system enable a virtual and a non-virtual component to be bundled together in a single binary. According to an embodiment of the present invention, an operating system may boot directly on host hardware or on a virtual machine manager. If the operating system boots directly on host hardware, the binary is capable of executing the non-virtual (“physical”) component code in the binary. If, on the other hand, the operating system boots onto a virtual machine manager, the binary is further capable of executing the virtual component code in the binary. In one embodiment, the virtual component may be para-virtualized, i.e., the component may be aware that it is running in a virtual environment.

### BACKGROUND

Interest in virtualization technology is growing steadily as processor technology advances. One aspect of virtualization technology enables a single host computer running a virtual machine monitor (“VMM”) to present multiple abstractions and/or views of the host, such that the underlying hardware of the host appears as one or more independently operating virtual machines (“VMs”). Each VM may function as a self-contained platform, running its own operating system (“OS”) and/or a software application(s). The VMM manages allocation of resources on the host and performs context switching as necessary to cycle between various VMs according to a round-robin or other predetermined scheme.

### BRIEF DESCRIPTION OF THE DRAWINGS

The present invention is illustrated by way of example and not limitation in the figures of the accompanying drawings in which like references indicate similar elements, and in which:

FIG. 1 illustrates an example of a typical virtual machine host;

FIGS. 2A-B illustrate various embodiments of the present invention in further detail;

FIG. 3 illustrates conceptually NIC Driver 200 according to one embodiment of the present invention; and

FIG. 4 is a flowchart illustrating an embodiment of the present invention.

### DETAILED DESCRIPTION

Embodiments of the present invention provide a method, apparatus and system for bundling virtualized and non-virtualized components. One embodiment of the invention is directed to bundling para-virtualized and non para-virtualized components. The term “para-virtualized” is well known to those of ordinary skill in the art and includes components (e.g., drivers) that are aware that they are running in a virtualized environment and that are capable of utilizing features of the virtualized environment to optimize performance and/or simplify implementation of a virtualized environment. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

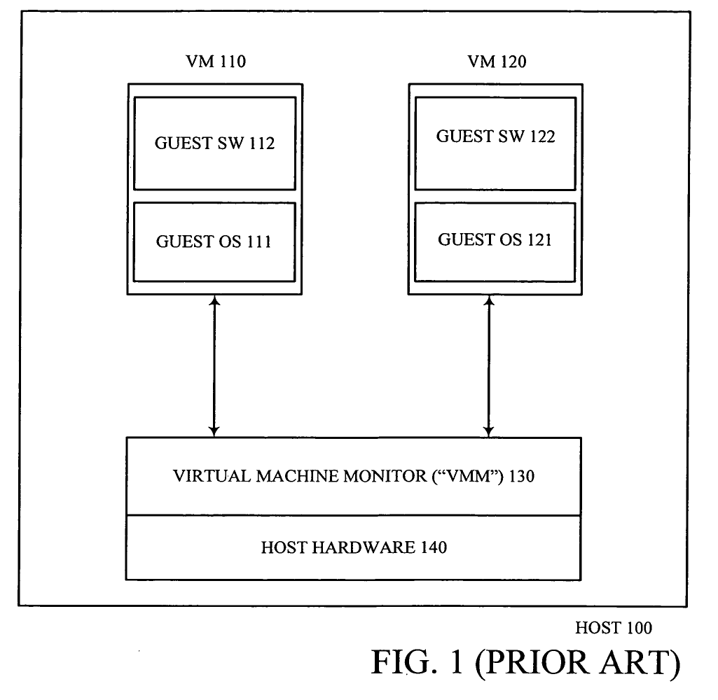

FIG. 1 illustrates an example of a typical virtual machine host platform (“Host 100”). As previously described, a virtual-machine monitor (“VMM 130”) typically runs on the host platform and presents an abstraction(s) and/or view(s) of the platform (also referred to as “virtual machines” or “VMs”) to other software. Although only two VM partitions are illustrated (“VM 110” and “VM 120”, hereafter referred to collectively as “VMs”), these VMs are merely illustrative and additional virtual machines may be added to the host. VMM 130 may be implemented in software (e.g., as a standalone program and/or a component of a host operating system), hardware, firmware and/or any combination thereof.

VM 110 and VM 120 may function as self-contained platforms respectively, running their own “guest operating systems” (i.e., operating systems hosted by VMM 130, illustrated as “Guest OS 111” and “Guest OS 121” and hereafter referred to collectively as “Guest OS”) and other software (illustrated as “Guest Software 112” and “Guest Software 122” and hereafter referred to collectively as “Guest Software”). Each Guest OS and/or Guest Software operates as if it were running on a dedicated computer rather than a virtual machine. That is, each Guest OS and/or Guest Software may expect to control various events and have access to hardware resources on Host 100. Within each VM, the Guest OS and/or Guest Software may behave as if they were, in effect, running on Host 100's physical hardware (“Host Hardware 140”). In reality however, VMM 130 has ultimate control over the events and hardware resources and allocates resources to the VMs according to its own policies.

Embodiments of the present invention may take advantage of emerging virtualized environments in which VMM 130 may boot an operating system image that is also bootable directly on Host Hardware 140. In other words, Host 100 may include an operating system capable of booting optionally onto Host Hardware 140 or on VMM 130. Thus, for example, in one scenario, Host Hardware 140 may be replaced with a virtualized implementation of the hardware when the operating system is booted on top of VMM 130. In this scenario, Host Hardware 140 may be virtualized for each VM on Host 100, i.e., each VM may see a virtual instantiation of the hardware. In this scenario, VMM 130 may replace the host ID of the physical device, thus effectively presenting an entirely different device (a virtual device) to the VMs on Host 100. Alternatively, Host Hardware 140 may be accessible directly if the operating system is booted without VMM 130.

Currently, if Host 100 boots a first time according to the first scenario described above (i.e., operating system booted on top of VMM 130) and then boots a second time according to the second scenario (i.e., operating system boots directly onto Host Hardware 140), it will appear to the operating system that the hardware on the system has changed. This apparent hardware change may cause a number of actions to take place such as new detection of hardware and new installation and configuration of devices and device drivers. These actions take place even in scenarios where it is desirable for the virtual hardware to have the exact same feature set as Host Hardware 140 and appear to be the native hardware when being virtualized. Additionally, the device drivers for various components on Host 100 may differ according to the boot scenario, i.e., Host 100 may include multiple drivers to support different boot scenarios. This multiple driver model may cause problems for the end user and/or Information Technology (“IT”) departments from a manageability perspective because updating each driver may become dependent on which driver happens to be active.

According to embodiments of the present invention, code for a virtual implementation of a component (“virtual component”) may be bundled with the non-virtualized implementation of the component (“non-virtual component” or “physical component”) into a single binary. The following description assumes that the component is a device driver, but embodiments of the invention are not so limited. Alternative embodiments may include any devices supported by Host 100. Additionally, in various embodiments, the device driver may be para-virtualized, i.e., the device driver may be aware that it is running in a virtualized environment and is capable of optimizing performance within this environment. According to one embodiment, the virtual component exposes the same interfaces, features and characteristics that are available on the physical device, thus making detection of the virtual environment transparent to the user and to applications running on Host 100.

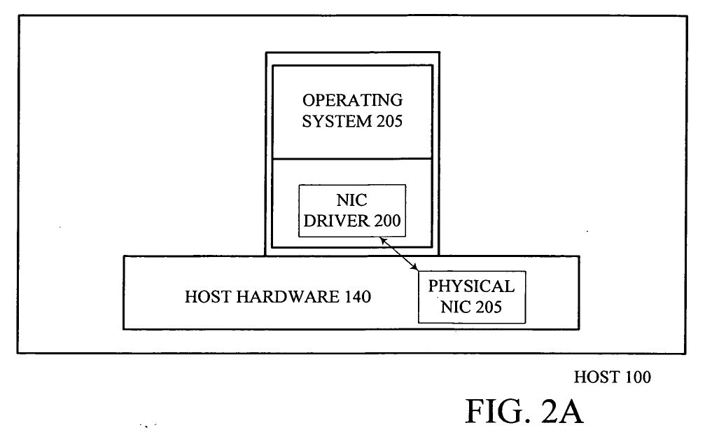

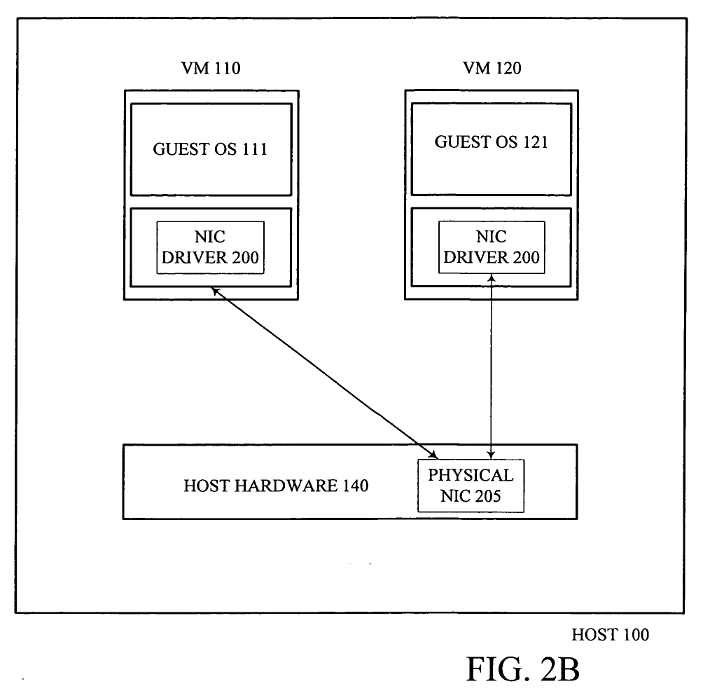

According to an embodiment of the present invention, the component code for a virtual implementation may be bundled with the component code for a non-virtual implementation. For the purposes of explanation, the following description assumes that the component is a device driver, but as previously stated, embodiments of the present invention are not so limited. FIGS. 2A-B illustrate two different boot scenarios for Host 100, where FIG. 2A illustrates an operating system image that boots directly onto the platform hardware while FIG. 2B illustrates an operating system image that boots onto VMM 130. As illustrated, in either scenario, the device driver (“NIC Driver 200”) corresponding to Physical NIC 205 is loaded into the operating system memory. In FIG. 2A, OS 210 is booted directly onto Host 100's hardware, i.e., a non-virtualized environment. In FIG. 2B, on the other hand, Host 100 is virtualized, i.e., Host 100 includes VMM 130, VM 110 and VM 120 and Guest OS 111 and Guest OS 121 are hosted by VMM 130.

According to embodiments of the present invention, NIC Driver 200 in both scenarios (FIGS. 2A-B) comprises the same driver image. In other words, NIC Driver 200 includes the code for both a virtualized and a non-virtualized version of Physical NIC 205. In one embodiment, when NIC Driver 200 is initialized, it determines whether it is running on the VMM or directly on Host Hardware 140 and branches to the appropriate implementation within the binary driver image. Thus, the code that is executing in FIG. 2A may comprise the non-virtualized code in NIC Driver 200 while the code executing in each VM in FIG. 2B may comprise the virtualized code in NIC Driver 200. NIC Driver 200 may make this determination in a variety of ways without departing from the spirit of embodiments of the present invention. For example, in one embodiment, NIC Driver 200 may issue a VM instruction (e.g., a VMCALL instruction). If the instruction fails, NIC Driver 200 may determine that that it is running in a non-virtualized environment because a VMM is required to handle a VM instruction. Alternatively, if the VM instruction succeeds, NIC Driver 200 may proceed under the assumption that it is running in a virtualized environment.

In yet another embodiment, NIC Driver 200 may determine whether it is running in a virtualized environment by examining the device IDs that are allocated. Host 100 may be configured such that different device IDs may be mapped to the same driver, where each of the device IDs identifies the boot mode (i.e., virtual or non-virtual). NIC Driver 200 may also be configured to search for the existence of specific devices to indicate which boot mode it is running in. Enhanced VMM 230 may also be modified to provide a library (e.g., an operating system library function such as a function in the OS kernel, a Dynamic Link Library, and/or an OS kernel driver accessible via a static call, a dynamic call, and/or an input/output control (“IOCTL”) function) that may be capable of detecting if the OS running on the host is virtualized. It will be readily apparent to those of ordinary skill in the art that any of the abovementioned techniques and/or others not described herein, may be utilized without departing from the spirit of embodiments of the present invention to determine whether NIC Driver 200 is running in a virtualized environment.

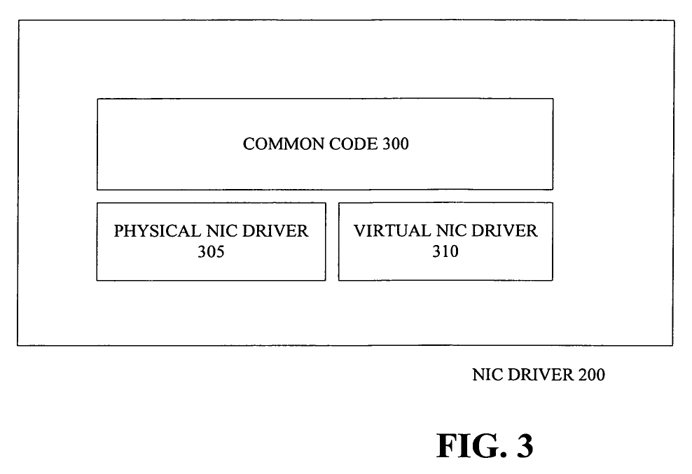

As previously described, Host 100 may include multiple drivers to support different boot scenarios. This multiple driver model may cause problems for the end user and/or Information Technology (“IT”) departments from a manageability perspective because updating each driver may become dependent on which driver happens to be active. Embodiments of the present invention alleviate this difficulty by enabling updates to more than one driver simultaneously. Specifically, as illustrated conceptually in FIG. 3, NIC Driver 200 comprises Common Code 300, Physical NIC Driver Code 305 and Virtual NIC Driver Code 310. In one embodiment, NIC Driver 200 may be updated in a single step. In contrast to existing schemes wherein only the currently active driver is accessible for update, according to embodiments of the present invention, both Physical NIC Driver Code 305 and Virtual NIC Driver Code 310 may be updated simultaneously, regardless of which driver is currently active. Any shared code in Common Code 300 may also be updated once and be accessible to both drivers. Accordingly, embodiments of the present invention may significantly simplify software management tasks.

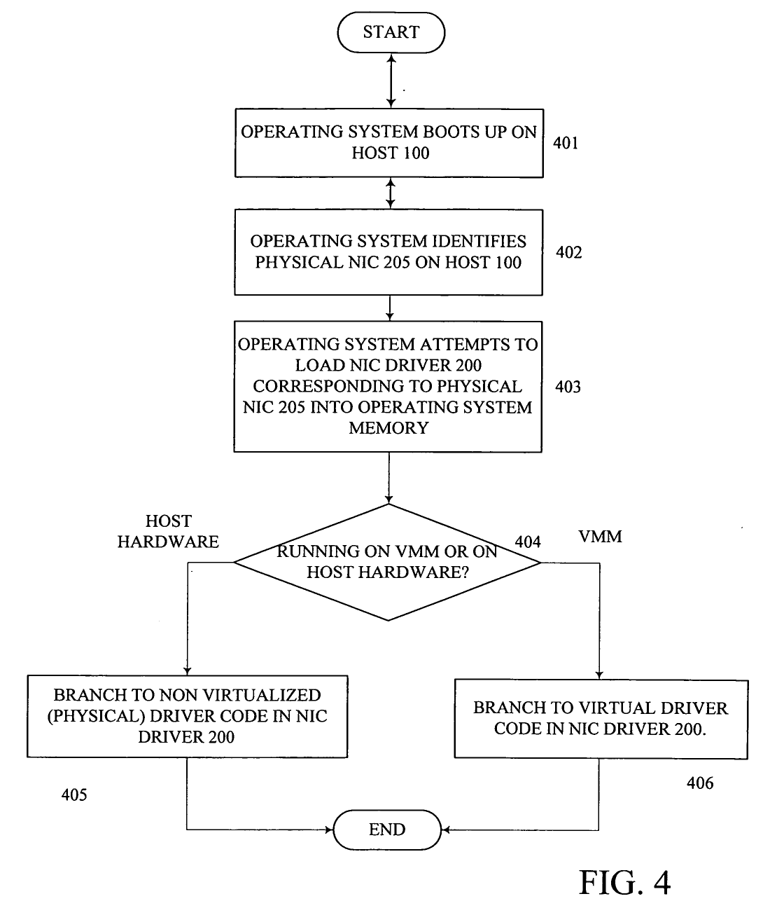

FIG. 4 is a flow chart illustrating an embodiment of the present invention in further detail. Although the following operations may be described as a sequential process, many of the operations may in fact be performed in parallel and/or concurrently. In addition, the order of the operations may be re-arranged without departing from the spirit of embodiments of the invention. In 401, an operating system is booted up on Host 100. The operating system then identifies Physical NIC 205 on Host 100 in 402 and in 403, the operating system attempts to load the corresponding device driver for Physical NIC 205, i.e., NIC Driver 200. In 404, NIC Driver 200 determines whether the operating system is running directly on Host Hardware 140 on Host 100 or on VMM 130 on Host 100. If the operating system is running on Host Hardware 140, NIC Driver 200 branches to the non-virtualized (i.e., physical) device code within the driver binary in 405. If, however, NIC Driver 200 determines that the operating system is running on VMM 130, NIC Driver 200 branches to the virtual device code within the driver binary in 406.

According to embodiments of the present invention, NIC Driver 200 may determine whether the operating system on Host 100 is running on Host Hardware 140 or VMM 130 in a variety of ways. For example, in one embodiment, prior to initializing, NIC Driver 200 may first examine Host 100 to determine whether a VMM is running. If NIC Driver 200 encounters VMM 130, it may automatically find the appropriate entry point in the driver binary to load the code for the virtual version of the driver. If, on the other hand, NIC Driver 200 does not see VMM 130 running on Host 100, it may automatically select the entry point in the driver binary to load the code for the physical version of the driver. Various other techniques may be utilized to determine whether the operating system on Host 100 is running on Host Hardware 140 or VMM 130 without departing from the spirit of embodiments of the present invention.

As previously described, NIC Driver 200 may be a para-virtualized component, i.e., the driver may be aware that it is running in a virtual environment. According to this embodiment, when executed, Virtual NIC Driver Code 310 in NIC Driver 200 may be aware that it is running on an operating system managed by VMM 130. As a result, Virtual NIC Driver Code 310 may elect to optimize its performance on Host 100 in a variety of ways. For example, in one embodiment, Virtual NIC Driver Code 310 may knowingly direct all communications to an interface on VMM 130, rather than current schemes whereby non para-virtualized drivers typically direct communications to the hardware. In the latter scenario, since the driver is not aware that it is virtualized and continues to direct communications to the hardware, VMM 130 typically intercepts each device access and emulates a device model for the fictitious hardware that VMM 130 presents. This device model may, but does not have to, utilize native system hardware to fulfill the intended function. This constant need to intercept communications and emulate device models incurs a performance cost on Host 100, and Virtual NIC Driver 310 may improve the overall performance on Host 100 by routing the communication directly to an interface on VMM 130.

Although the above description assumes that the bundled components are NIC device drivers, embodiments of the invention are not so limited. Thus, for example, in an alternate embodiment, the bundled component may be an operating system, i.e., a para-virtualized and non-paravirtualized version of an operating system may be bundled in a single binary. Similar to the description above, the bundled operating system may first determine whether it is running directly on Host Hardware 140 or on VMM 130 and load the appropriate code from a single operating system binary. Various other devices and/or components on Host 100 may also be similarly bundled without departing from the spirit of embodiments of the present invention.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
identifying whether a virtual machine manager is present in a host;
if the virtual machine manager is present, selecting and executing a virtual component from a bundle comprising the virtual component and a non-virtual component; and
if the virtual machine manager is absent, selecting and executing the non-virtual component from the bundle.

2. The method according to claim 1 further comprising receiving an updated bundle including an updated virtual component and an updated non-virtual component.

3. The method according to claim 2 further comprising automatically replacing the virtual component with the updated virtual component and the non-virtual component with the updated non-virtual component, regardless of which is currently executing.

4. The method according to claim 1 further comprising:
booting an operating system on a virtual machine manager if the virtual machine manager is present; and
booting the operating system directly on host hardware if the virtual machine manager is absent.

5. The method according to claim 4 wherein identifying whether the virtual machine manager is present further comprises:
sending out a virtual instruction;
determining that the virtual machine manager is present if the virtual instruction succeeds; and
determining that the virtual machine manager is absent if the virtual instruction fails.

6. The method according to claim 4 wherein identifying whether the virtual machine manager is present further comprises:
identifying a first device identification for a virtual boot mode and a second device identification for a non-virtual boot mode; and
if the first device identification is active, determining that the virtual machine manager is present; and
if the second device identification is active, determining that the virtual machine manager is absent.

7. The method according to claim 4 wherein identifying whether the virtual machine manager is present further comprises:
determining whether an operating system on the host is virtualized by examining an operating system library service;
if the operating system on the host is virtualized, determining that the virtual machine manager is present; and
if the operating system on the host is non-virtualized, determining that the virtual machine manager is absent.

8. The method according to claim 4 wherein the virtual component is para-virtualized and capable of communicating directly with an interface on the virtual machine manager.

9. The method according to claim 8 wherein the non-virtual component is capable of communicating directly with the host hardware.

10. The method according to claim 1 wherein the virtual component and the non-virtual component correspond to a physical device on the host and the method further comprises enabling a user to transparently interact with the physical device via one of the virtual component and the non-virtual component.

11. The method according to claim 1 further comprising wherein the virtual component and the non-virtual component correspond to a physical device on the host and the method further comprises enabling an application to execute on the host and interact transparently with the physical device via one of the virtual component and the non-virtual component.

12. An system, comprising:
a processor;
a firmware coupled to the processor;
a memory coupled to the processor and the firmware;
a storage device coupled to the memory, the processor and the firmware;
a binary image in the storage device, the binary image comprising a virtual component and a non-virtual component, the binary image capable of selectively executing one of the virtual component and the non-virtual component.

13. The system according to claim 12 wherein the binary image determines whether to execute one of the virtual component and the non-virtual component by identifying whether a virtual machine manager is present in the system.

14. The system according to claim 13 wherein if a virtual machine manager is present in the system, the binary selectively executes the virtual component and if the virtual machine manager is absent in the system, the binary selectively executes the non-virtual component.

15. The system according to claim 12 wherein the binary image represents a device driver for one of a network interface card (“NIC”), a display, an input/output (“I/O”) controller and a storage controller.

16. An article comprising a machine-accessible medium having stored thereon instructions that, when executed by a machine, cause the machine to:
identify whether a virtual machine manager is present in a host;
if the virtual machine manager is present, select and execute a virtual component from a bundle comprising the virtual component and a non-virtual component; and
if the virtual machine manager is absent, select and execute the non-virtual component from the bundle.

17. The article according to claim 16 wherein the instructions, when executed by the machine, further cause the machine to receive an updated bundle including an updated virtual component and an updated non-virtual component.

18. The article according to claim 17 wherein the instructions, when executed by the machine, further cause the machine to automatically replace the virtual component with the updated virtual component and the non-virtual component with the updated non-virtual component, regardless of which is currently executing.

19. The article according to claim 16 wherein the instructions, when executed by the machine, further cause the machine to:
boot an operating system on a virtual machine manager if the virtual machine manager is present; and
boot the operating system directly on host hardware if the virtual machine manager is absent.

20. The article according to claim 19 wherein the instructions, when executed by the machine, further cause the machine to identifying whether the virtual machine manager is present by:
sending out a virtual instruction;
assuming that the virtual machine manager is present if the virtual instruction succeeds; and
assuming that the virtual machine manager is absent if the virtual instruction fails.

21. The article according to claim 19 wherein the instructions, when executed by the machine, further cause the machine to determine if the virtual machine manager is present by:
identifying a first device identification for a virtual boot mode and a second device identification for a non-virtual boot mode; and
if the first device identification is active, assuming that the virtual machine manager is present; and
if the second device identification is active, assuming that the virtual machine manager is absent.

22. The article according to claim 19 wherein the instructions, when executed by the machine, further cause the machine to determine if the virtual machine manager is present by:
determining whether an operating system on the host is virtualized by examining an operating system library service;
if the operating system on the host is virtualized, determining that the virtual machine manager is present; and
if the operating system on the host is non-virtualized, determining that the virtual machine manager is absent.

23. The article according to claim 19 wherein the virtual component is para-virtualized and the instructions, when executed by the machine are further capable of causing the para-virtualized component to communicate directly with an interface on the virtual machine manager.

24. The article according to claim 23 wherein the instructions, when executed by the machine, are further capable of causing the non-virtual component to communicate directly with the host hardware.
